(19) United States
(12) Patent Application Publication
(10) Pub. No.: US 2015/0377718 A1
(43) Pub. Date: Dec. 31, 2015

(54) APPARATUS AND METHOD FOR SERVICE REPLACEMENT OF DAMAGED EXHAUST TEMPERATURE SENSOR MOUNTING BOSS

(71) Applicant: Jeffrey Thomas Eichen, Savage, MN (US)

(72) Inventor: Jeffrey Thomas Eichen, Savage, MN (US)

(21) Appl. No.: 14/318,621

(22) Filed: Jun. 28, 2014

(51) Int. Cl. G01K 13/02

(52) U.S. Cl. CPC G01K 13/02

(57) ABSTRACT

An apparatus and method for the replacement of a damaged exhaust temperature sensor mounting boss for automobiles in the event an integral shrouded mounting boss becomes damaged. The present invention provides a means to replace only the sensor mounting boss (used interchangeably with bung and fitting hereinafter), rather than having to replace an entire exhaust emissions after-treatment component. This is accomplished by utilizing a developed removal technique of simultaneously applying extreme heat and torque to cleanly remove a damaged integral sensor mounting boss. In conjunction with the installation of a service replacement mounting boss which has also been developed to embody a new form as a stand-alone replacement part. This invention allows for the benefits of cost savings and reduced vehicle repair downtime, as well as a reduced consumption of rare earth metals used in the construction of exhaust emissions after-treatment devices.

### CROSS REFERENCE TO RELATED APPLICATIONS

Not applicable to this application

### STATEMENT REGARDING FEDERALLY SPONSORED RESEARCH OR DEVELOPMENT

Not applicable to this application

### BACKROUND OF THE INVENTION

1. Field of the Invention

The present invention relates to a service method and replacement mounting boss for automotive exhaust temperature sensors.

2. Description of the Related Art

Whereas the combustion of petroleum based hydrocarbon fuels for automobiles has been, and continues to cause negative environmental consequences, federal automotive emissions standards have become increasingly more stringent in an effort to reduce this impact. To meet these requirements, automotive powertrain management systems have evolved to become increasingly more complex such as to utilize multiple on-board computers. These computers process and share data from a plurality of sensors in order to command the most efficient fueling and engine operating strategies possible. This is true of gasoline and Diesel powered vehicles, as well as alternative fueled vehicles.

As is often the circumstance with automobiles, components sometimes require replacement. For the purpose of this invention, this is especially true of the temperature sensors FIG. 8 found most frequently in, but not limited to modern Diesel exhaust systems. Virtually every component in the exhaust system on a 2008 model and newer Diesel powered vehicle is actually an emissions control device. Modern Diesel powered vehicles use a number of after-treatment systems to clean the exhaust gas before it leaves the tailpipe. This includes; catalytic converters (U.S. Pat. No. 3,841,842A) which reduce hydrocarbon emissions, particulate filters (U.S. Pat. No. 5,298,046 A) which collect soot particles until a regeneration or self cleaning event occurs which converts the soot emissions to ash. Also, there are selective catalyst reduction systems (U.S. Pat. No. 8,728,422 & US20120269705A1) which inject a fluid in to the exhaust to react chemically, thereby reducing emissions of NOx (oxides of nitrogen). Exhaust gas recirculation systems (U.S. Pat. No. 6,216,458) also reduce NOx emissions through the lowering of combustion temperatures by reducing the oxygen content of the air charge under certain conditions. The Diesel exhaust gas temperature sensors FIG. 8 (used interchangeably with the term “EGT sensors” hereinafter), are used by the powertrain management computers to monitor the operation of the aforementioned after-treatment systems. Industry experience has shown EGT sensors occasionally require replacement.

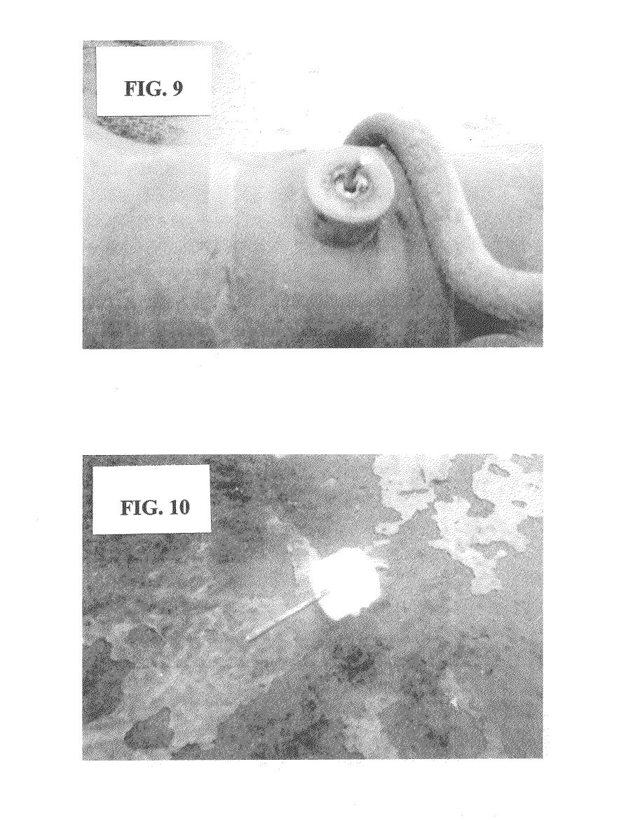

EGT sensors are temperature sensing probes FIG. 8, installed into Shibayama-style integral mounting bosses FIG. 9 (20020039378 A1) at various points along the exhaust system. This allows for the temperatures at those points to be monitored by the powertrain management computers in order to control and monitor the operation of the exhaust emissions after-treatment systems. In most cases, when the EGT sensor requires replacement, it is a simple matter of un-screwing the old sensor, and screwing in the new sensor. Occasionally however, their threads become seized, and they break off inside their respective mounting boss during replacement FIG. 9. This is unfortunate, because the mounting boss in to which they thread—is an integral part of what is usually a highly expensive emissions after-treatment component. This means a broken off EGT sensor typically renders that entire after-treatment component defective and in need of replacement.

### SUMMARY OF THE INVENTION

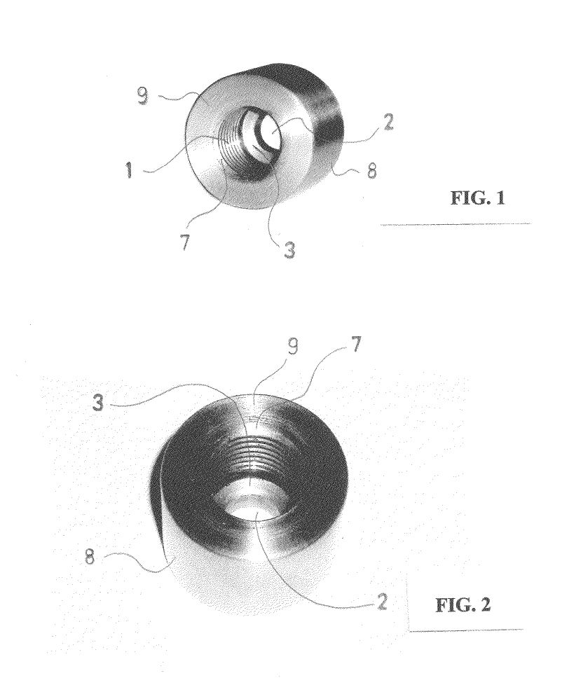

This invention is a lower cost automotive repair solution, in the form of a stand-alone service replacement EGT sensor mounting boss FIG. 1 and replacement procedure FIG. 10-FIG. 14. This invention provides a means to resolve the problem of broken off Original equipment EGT sensors FIG. 9 of specific types. This service replacement part, allows for the replacement of just the threaded EGT sensor mounting boss FIG. 1, instead of having to replace the entire after-treatment component. This invention has already proven to be a much more cost effective option, so much so, that an industry technical article has been published about these, and has been referenced.

To be clear, no claim is being made on sensor mounting bosses generally, as replacement mounting bosses for most exhaust oxygen sensors are readily available from several suppliers, and have been for years. One example of many is U.S. Pat. No. 8,459,004 by Chang. So too, have various un-shrouded mounting bosses been available for aftermarket style EGT sensors—often used for customer installed pyrometer gauges and performance devices. Nor is this a claim on the original shrouded mounting bosses which come equipped on these vehicles from the factory and are an integral part of their respective exhaust after-treatment component (20020039378 A1) FIG. 9. What is being claimed is an improvement to the originally equipped EGT sensor mounting bosses to allow for a lower cost repair solution should one become damaged. To be specific, the development of service replacement shrouded mounting bosses as a stand-alone repair component FIG. 1 for original equipment style exhaust temperature sensors FIG. 8 of two very specific thread and shrouded seat configurations. This invention allows for an exhaust after-treatment component with a damaged Shibayama-style integral mounting boss FIG. 9, to be repaired FIG. 16, instead of having to discard and replace the entire after-treatment component.

### BRIEF DESCRIPTION OF THE IMAGES

FIG. 1 and FIG. 2 are top views of the service replacement mounting boss which depict the internal structure such as to show the top surface 9, optional chamfer 7, threads 1, shrouded seat 3, temperature probe hole 2, and exterior welding surface 8.

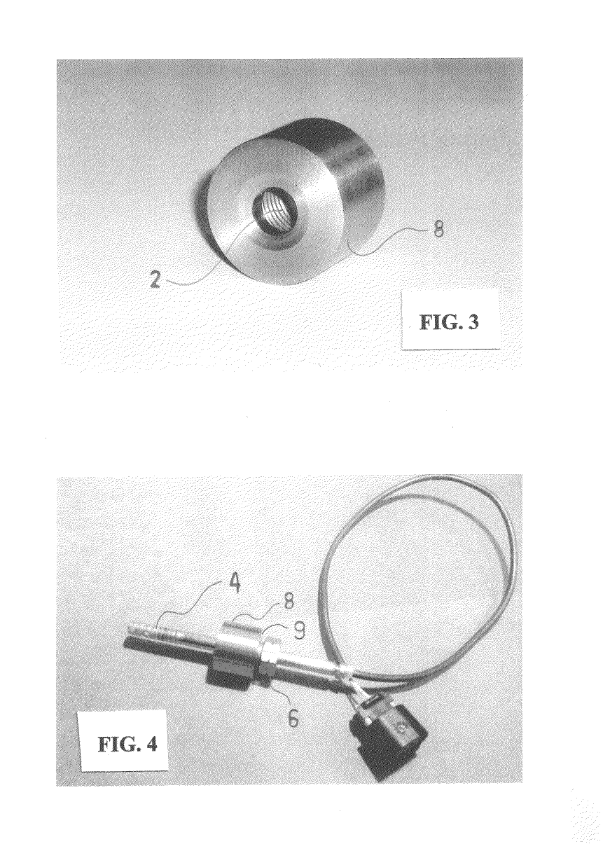

FIG. 3 is a bottom view of the service replacement mounting boss showing the smaller hole 2 through which the temperature sensor probe 4 protrudes.

FIG. 4 shows an EGT sensor threaded into a service replacement mounting boss.

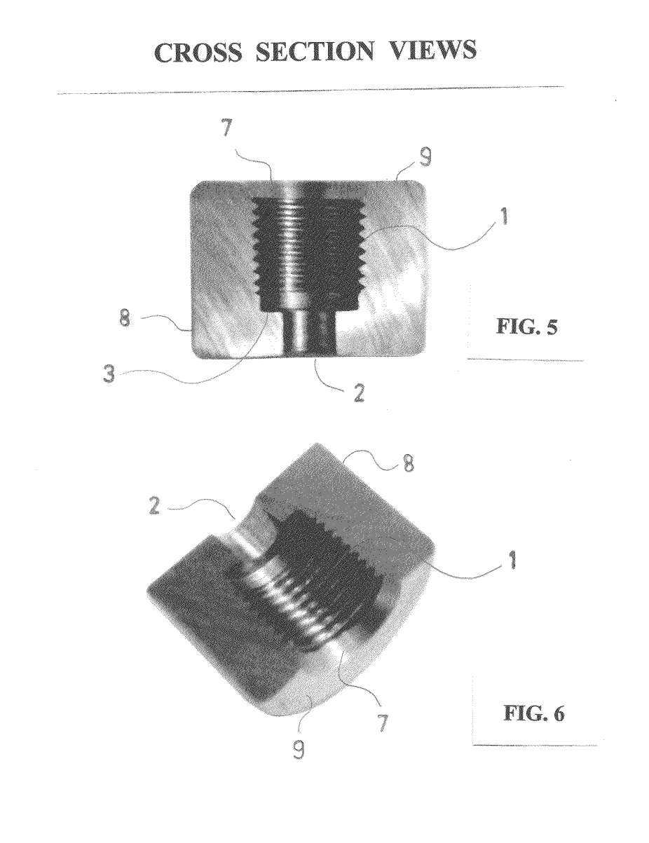

FIG. 5 and FIG. 6 are cutaway views showing a cross section to reveal the internal structure of the service replacement mounting boss.

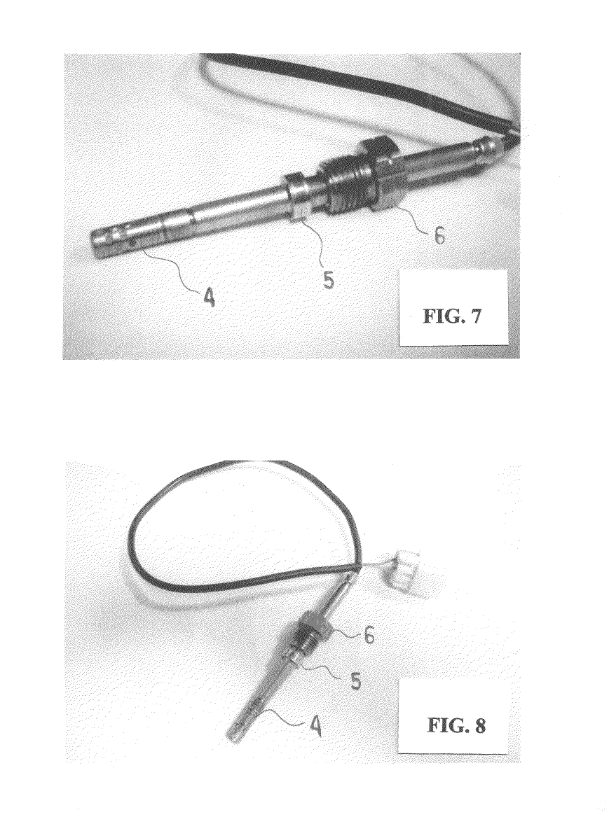

FIG. 7 and FIG. 8 are images of one of the types of exhaust temperature sensors for which these replacement mounting bosses are intended.

FIG. 9 depicts an EGT sensor broken off inside the originally equipped integral sensor mounting (the problem which inspired this invention).

FIG. 10 depicts the aforementioned broken sensor and mounting assembly upon removal utilizing the developed technique of applying extreme heat and torque simultaneously.

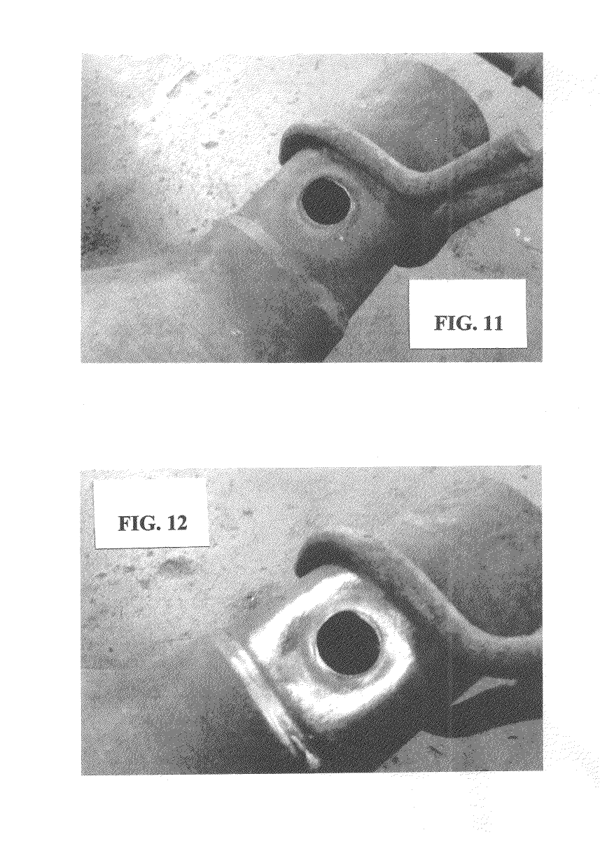

FIG. 11 depicts the hole created in an exhaust emissions after-treatment component upon removal of its original integral temperature sensor mounting boss.

FIG. 12 depicts the repair site of FIG. 11 after cleaning and preparation for welding.

FIG. 13 depicts a service replacement EGT sensor mounting boss positioned on the repair site prior to welding.

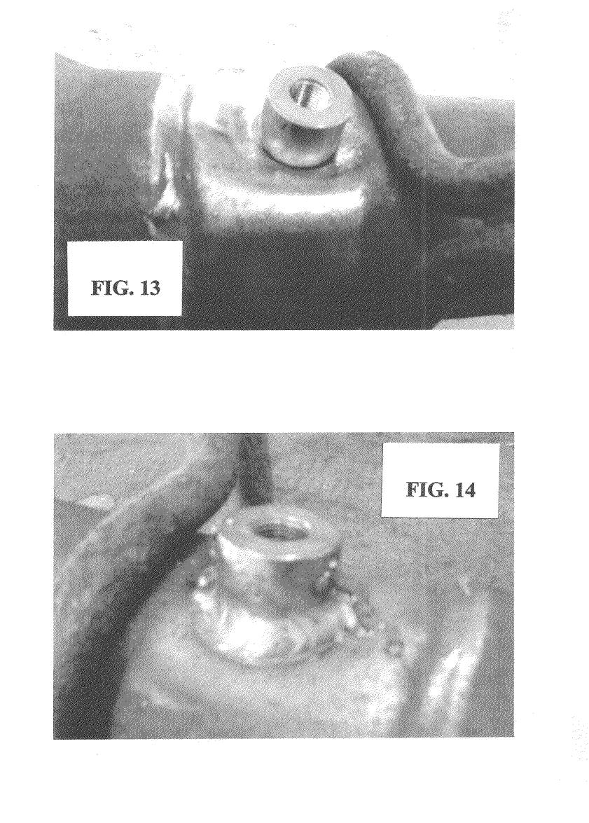

FIG. 14 depicts a repaired exhaust emissions after-treatment component upon completion of affixing a service replacement EGT sensor mounting boss by welding.

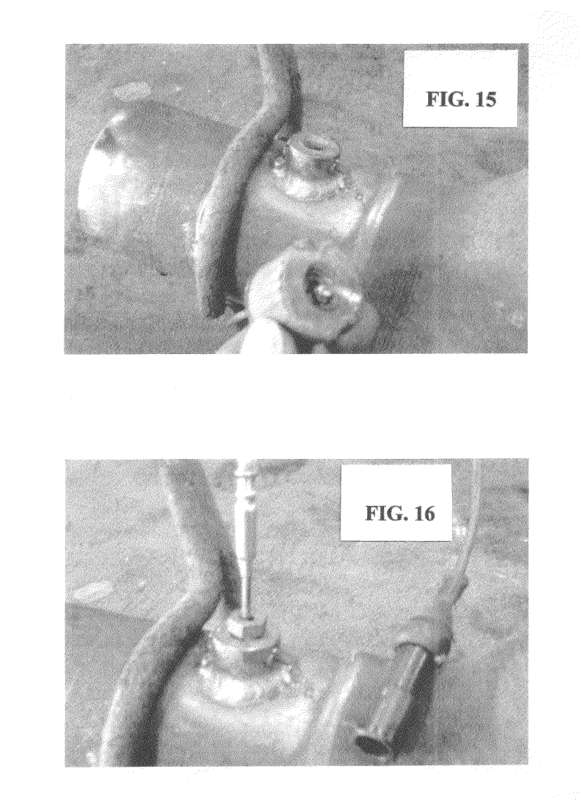

FIG. 15 is an image of a repaired emissions after-treatment component with its original damaged integral sensor mounting in the foreground.

FIG. 16 depicts a new EGT sensor installed into a repaired exhaust system component.

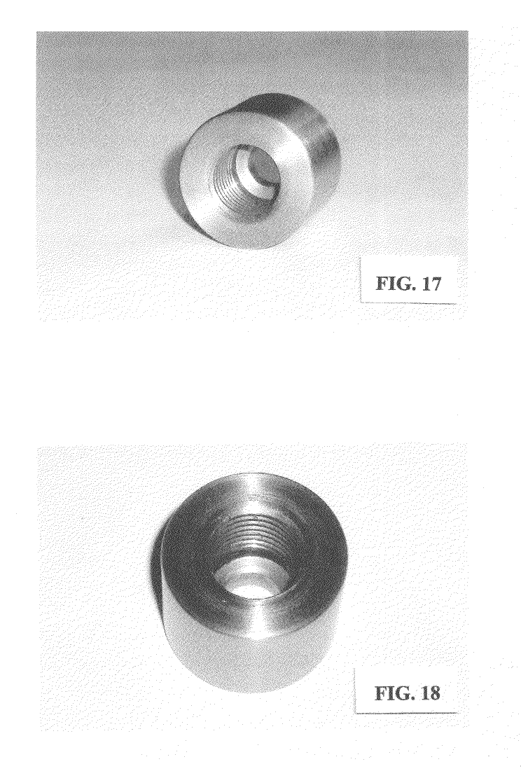

FIG. 17 and FIG. 18 are additional photographs of the service replacement mounting boss without any technical drawing added.

### DESCRIPTION OF THE PREFERRED EMBODIMENTS

The service replacement EGT sensor mounting boss is comprised of a machined steel or stainless steel bar in a diameter of approximately 1 inch. It is approximately 0.75 inches in total height; though the external specifications are less important and could vary. It is the internal specifications that enable it to function, by allowing it to receive and seal against specific types of EGT sensors. There are two different internal configurations for which this claim is being made. One has 12 mm×1.25 mm internal threads 1; the other has 14 mm×1.5 mm internal threads 1. Unlike the replacement mounting bosses currently available for oxygen sensors or for aftermarket style EGT sensors, these are not machined to their threading diameter all the way through, rather, they are only machined to their threading diameter approximately 0.5 inches. A smaller hole 2 is machined through the remainder of the material to allow for a shrouded sealing surface or seat 3. The smaller hole at the bottom of the mounting boss 2 is large enough to allow for the temperature probe 4 to protrude through, but not the EGT sensor's seat 5. This allows for a sealing off of exhaust gasses, as well as a tightening of the sensor's nut 6 once the sensor's seat 5 bottoms against the corresponding inverse seat 3 within the mounting boss. The invention of these service replacement mounting bosses allows for a damaged integral EGT sensor mounting FIG. 9 to be severed from its respective after-treatment component FIG. 10 through a technique involving a combination of applying extreme heat approaching the melting point of steel, while simultaneously applying torque to the originally equipped integral mounting boss. Whereupon one of these service-replacement mounting bosses can be affixed in its place by means of standard welding or brazing practices FIG. 14. Once a service replacement EGT sensor mounting boss has been affixed, a new sensor may then be installed FIG. 16. This restores the vehicle to operation for a fraction of the cost of replacing the entire after-treatment component—which had been the only repair option heretofore.

What is claimed is:

1. A service replacement shrouded mounting boss, comprised of steel, or stainless steel, or aluminum, or any alloy of the aforementioned, as a stand-alone replacement part, and in to which an original equipment style exhaust temperature sensor may be installed.

2. The service replacement mounting boss of claim 1, wherein an internal thread pitch of 12 mm×1.25 mm extends from the top surface or chamfer thereof, to or near a seat within, located 5 mm to 30 mm below said top surface.

3. The service replacement mounting boss of claim 2, wherein the internal seat has a hole extending through the seat and lower surface with a diameter range of 3 mm to 11 mm, thereby allowing protrusion clearance for a temperature sensing probe.

4. The service replacement mounting boss of claim 1, wherein an internal thread pitch of 14 mm×15 mm extends from the top surface or chamfer thereof, to or near a seat within, located 5 mm to 30 mm below said top surface.

5. The service replacement mounting boss of claim 4, wherein the internal seat has a hole extending through the seat and lower surface with a diameter range of 5 mm to 13 mm, thereby allowing protrusion clearance for a temperature sensing probe.
